(19) United States
(12) Patent Application Publication
(10) Pub. No.: US 2011/0217144 A1
(43) Pub. Date: Sep. 8, 2011

(54) FASTENER FOR FLEXIBLE ELEMENT COUPLINGS

(76) Inventors: Matthew A. McGinnity, Timonium, MD (US); Charles A. Sakers, Odenton, MD (US); Scott M. Levy, Columbia, MD (US)

(21) Appl. No.: 13/038,616

(22) Filed: Mar. 2, 2011

Related U.S. Application Data
(60) Provisional application No. 61/310,547, filed on Mar. 4, 2010.

(51) Int. Cl. F16B 35/04

(52) U.S. Cl. 411/411

(57) ABSTRACT

A fastener comprising a head; a first section extending from the head and defining a first outside diameter, wherein the first section is unthreaded; and a second section co-axially extending from the first section and defining a second outside diameter. The second section being threaded and the second outside diameter being smaller than the first outside diameter.

### CROSS-REFERENCE TO RELATED APPLICATIONS

This application claims the benefit of U.S. Provisional Application No. 61/310,547, filed on Mar. 4, 2010. The entire disclosure of the above application is incorporated herein by reference.

### FIELD

The present disclosure relates to fasteners and, more particularly, relates to fasteners for coupling flexible elements.

### BACKGROUND AND SUMMARY

This section provides background information related to the present disclosure which is not necessarily prior art. This section also provides a general summary of the disclosure, and is not a comprehensive disclosure of its full scope or all of its features.

Flexible couplings typically employ one or more flexible elements to simultaneously transmit torque and accommodate misalignment of the connected equipment. Some types of flexible couplings employ flexible elements that are connected to the other coupling components by means of fasteners and transmit torque circumferentially between these fasteners.

Typically, bolts or screws with similar or consistent body and thread diameters are used to connect flexible elements to the other coupling components. Fasteners with consistent diameter of thread and body can be difficult to assemble and the threads can become damaged during assembly and disassembly.

In some conventional designs, a single or multi-piece bushing is assembled through the holes in the flex element and mating component in order to align and connect the two components, and a fastener (or fasteners) is (are) assembled with this bushing in order to clamp the flex element to the mating component. In simpler designs, a fastener is assembled through the holes in the flex element and mating component, and this fastener is used to both align the two components and clamp them together. However, many of these conventional solutions are cumbersome, difficult to install, or easily damaged.

The present teachings, however, provide a single fastener having a unique construction that can be used to both align a flex element with the mating component, and further clamp or fasten the flex element and mating component together.

In many applications, it is generally advantageous to have a minimal clearance between the fasteners and the holes of the flex element and the mating component. Therefore, the holes in the flex element must be accurately aligned with the holes in the mating components in order to install the fasteners. As a result, it is possible to damage the threads on the fastener as they are assembled and disassembled through the holes in the flex element and mating component.

In some flexible element designs it can be advantageous to introduce a pre-tension into the flexible element sections between the fasteners in order to minimize compression or buckling of these sections when torque is applied. One method to do this is to design the bolt circle (that is, the radial position of the through hole) of the flexible element to be slightly smaller than the bolt circle of the coupling component to which it is connected. In this case, a pre-tension is introduced into the flexible element when it is connected to the other coupling components with the fasteners provided. Depending on the amount of pre-tension and the size of the coupling, conventional solutions can be difficult to assemble and the fasteners can potentially be damaged during assembly and disassembly.

The fasteners described here are designed to facilitate installation through a flexible element and a mating component, and also to protect the threads on the fasteners during installation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial cross-sectional view illustrating a fastener according to the principles of the present teachings disassembled from a flexible element and a mating component;

FIG. 2 is a partial cross-sectional view illustrating the fastener engaged with the mating component at a first diameter section and engaged with the flexible element at a second diameter section;

FIG. 3 is a partial cross-sectional view illustrating the fastener engaged with the mating component at the first diameter section and engaged with the flexible element at the first diameter section;

FIG. 4 is a partial cross-sectional view illustrating a fastener according to some embodiments of the present teachings disassembled from a flexible element and a mating component;

FIG. 5 is a side view of a fastener according to some embodiments of the present teachings having a thread cover, wherein the fastener comprises a tapered shoulder for installation and the thread cover defines an outer diameter that is smaller than the first diameter section of the fastener;

FIG. 6 is a side view of a fastener according to some embodiments of the present teachings having a thread cover, wherein the thread cover comprises a tapered tail section for installation extending from the outer diameter of the threaded cover to the first diameter section of the fastener;

FIG. 7 is a side view of a fastener according to some embodiments of the present teachings having a thread cover, wherein the thread cover defines an outer diameter that is similar or consistent with to the first diameter section of the fastener; and

FIG. 8 is an assembled view of a fastener according to the principles of the present teachings together with a flexible element and mating components.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

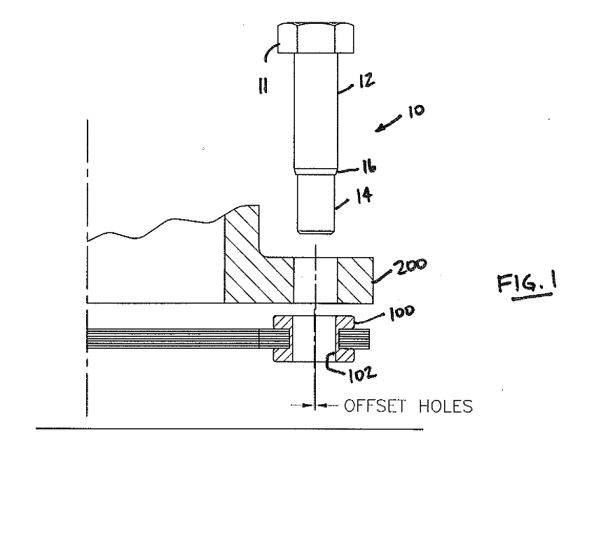

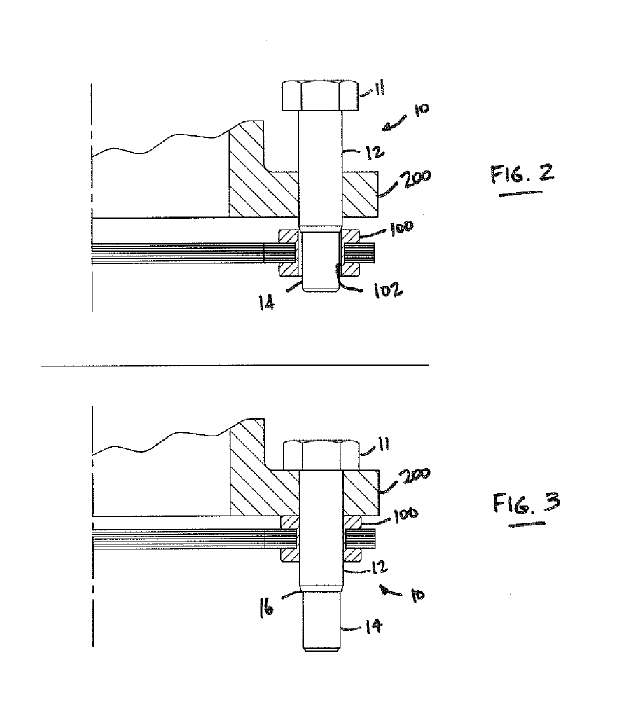

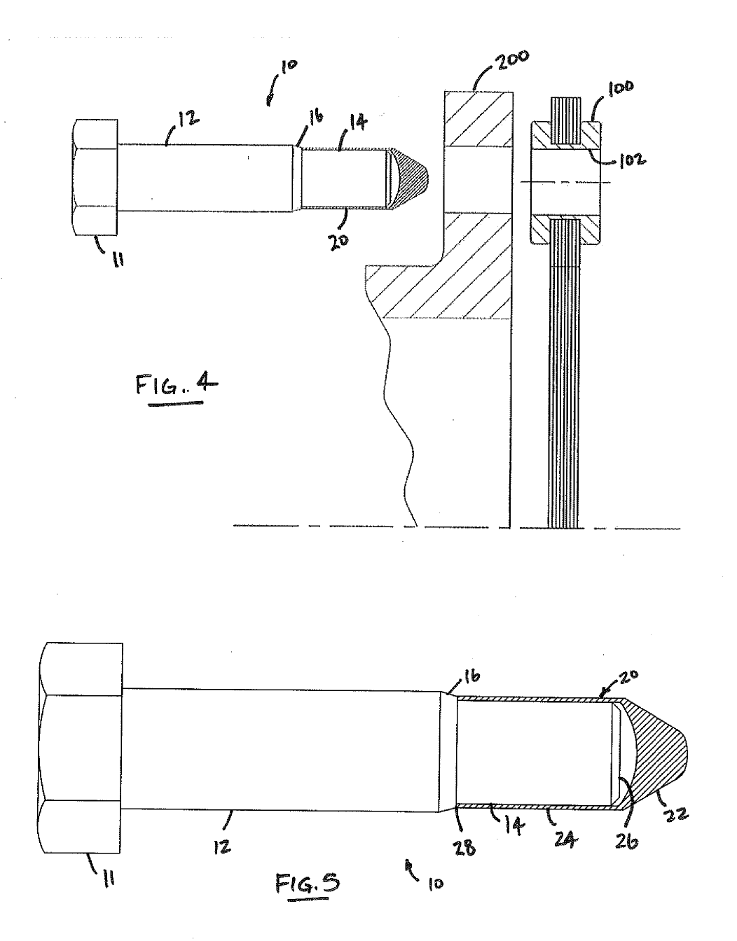

According to the principles of the present teachings, as illustrated in FIGS. 1-8, a fastener 10 is provided having a head 11, a first diameter section 12 and a second diameter section 14. In some embodiments, first diameter section 12 can be an unthreaded section defining a first outer diameter dimension. In some embodiments, second diameter section 14 can be a threaded section defining a second outer diameter dimension. As can be seen in the figures, second outer diameter dimension of second diameter section 14 can be smaller than first outer diameter dimension of first diameter section 12.

Unlike a traditional shoulder bolt, the outer diameter of the unthreaded section is designed specifically to prevent threaded second diameter section 14 from contacting a flexible element 100 during assembly and disassembly.

In some embodiments, fastener 10 can comprise a transition section 16, such as a gradually tapered transition section (FIGS. 1-5), between threaded second diameter section 14 and the unthreaded first diameter section 12 designed to facilitate assembly with the flexible element.

In some embodiments, threaded second diameter section 14 of fastener 10 is designed to be sufficiently smaller than the unthreaded first diameter section 12 of fastener 10 to ensure that threaded second diameter section 14 does not make contact with the through-holes 102 in flexible element 100 during assembly or disassembly. This provides the advantage of protecting the threads on threaded second diameter section 14 of fastener 10 during assembly and disassembly.

It should be appreciated that the smaller diameter of threaded second diameter section 14 of fastener 10 provides an additional benefit in that a lower tightening torque is required (because of the reduced outside diameter relative to single diameter fasteners). This is advantageous in that smaller tooling requirements are required and, thus, safety can be improved. Moreover, less force is required by the installer during installation.

The present teachings take into account various design criteria, such as the location tolerances of the through-holes relative to one another as well as any intentionally designed offset of the holes for pre-tension or other reasons. Moreover, the present teachings take into account material strength considerations and the necessary size of threaded second diameter section 14 to achieve the required fastener tension and clamping force for flexible element 100 as required for proper operation of the flexible coupling.

Still referring to FIGS. 1-5, in some embodiments tapered, transition section 16 of fastener 10 can be configured and sized to make first contact with the holes 102 in flexible element 100 and to facilitate assembly. The tapered, transition section 16 can begin just past threaded second diameter section 14. In this way, the tapered contour of transition section 16 can provide a smooth transition to permit holes 102 of flexible element 100 to contact this camming surface and be properly positioned on unthreaded first diameter section 12. Generally, a taper of less than 45 degrees would be advantageous in providing a smooth transition. As mentioned above, in this way, the threads are protected by avoiding contact during assembly and disassembly. Another advantage of this design is that the taper aligns the flex element with the mating component as fastener 10 is assembled through both, which makes assembly easier for the installer. Further, the taper facilitates assembly in the case where the holes in the two components are misaligned, either simply due to tolerances or intentionally by design, minimizing the force required to assemble fastener 10s.

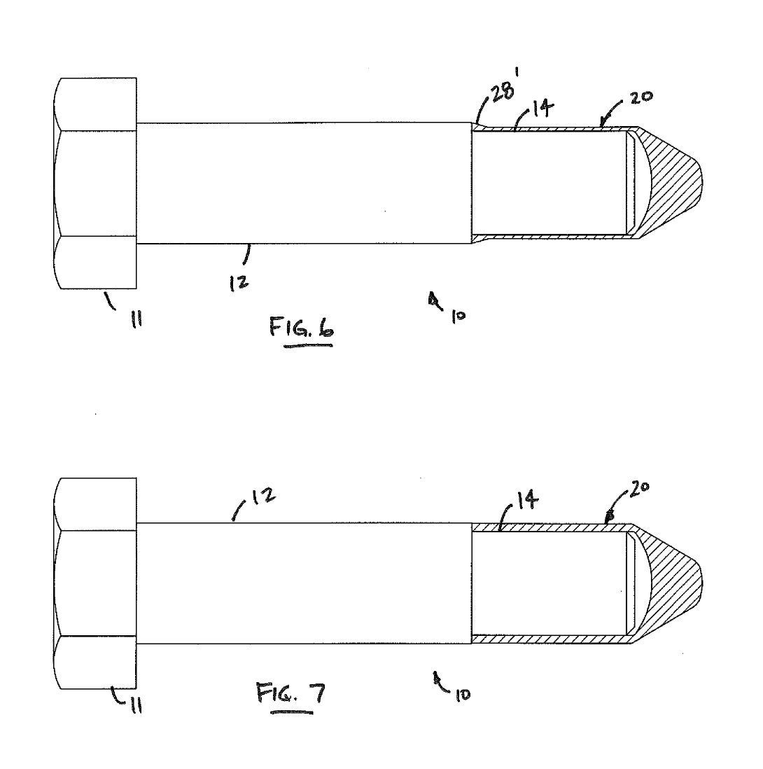

With particular reference to FIGS. 5-6, in some embodiments, fastener 10 can comprise a thread cover 20 disposed over threaded second diameter section 14 to protect the threads thereof during shipment, handling, assembly, disassembly, and the like. The shape further facilitates installation in the case where the holes are not initially well-aligned in addition to being designed for pre-tension. Thread cover 20, in some embodiments, can comprise a sheath-like member being made of a predetermined material sufficient to protect the threads, such as plastic, having a tip portion 22 protecting the end 26 of fastener 10 and a sheath portion 24 generally surrounding the threads. Thread cover 20 can terminate at an end 28 that is generally adjacent transition section 16 of fastener 10.

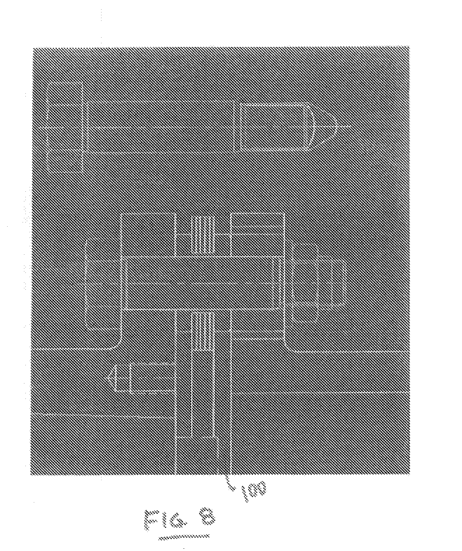

It should be appreciated that thread cover 20 can be sized and/or configured in various combinations. By way of non-limiting example, in some embodiments, thread cover 20 can be generally consistent in outside diameter (FIG. 5) and be sized such that its outer diameter is smaller than the first diameter of first diameter section 12. In such case, tapered, transition section 16 can be used. In some embodiments, thread cover 20 can have a trailing sloped end 28′ (FIG. 6) that serves to transition from the outside diameter of thread cover 20 to the first diameter section 12, thereby eliminating the need for tapered transition section 16. In this regard, fastener 10 can define a 90 degree transition section 16. Moreover, in some embodiments, thread cover 20 can be generally consistent in outside diameter (FIG. 7) and be sized such that its outer diameter is equal to the first diameter of first diameter section 12, thereby eliminating the need for tapered transition section 16. In this regard, fastener 10 can define a 90 degree transition section 16. It should be understood that thread cover 20 can be made of a material or include a coating that provides a low friction surface to facilitate assembly of flexible element 100 and mating components 200. Moreover, in some embodiments, thread cover 20 can be made of plastic, metal, composite, rubber, polymer, wax/shellac (meltable material), soluble material, or other materials. In some embodiments, thread cover 20 can be installed on fastener 10 by threaded fit, slip fit, tight fit, shrunk on, or other method. Moreover, thread cover 20 can comprises a flat or tapered tip portion 22. Thread cover 20 can be removed from fastener 10 by using an extension, pull tab, threaded insert for puller/pusher rod, or use a meltable/soluble material. Such features can be integral formed or require an additional part to permit it to be grabbed or otherwise removed. Moreover, thread cover 20 could be a perforated part that separates from the bolt easily or mounted by heating the protector and then reheat to remove.

Generally, it should be understood that the principles of the present teachings provide a number of advantages over the prior art. Specifically, it should be recognized that the present teachings can be used in any assembly where two components have offset holes either by design or through tolerance buildup, thereby replacing tapered alignment pins.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A fastener comprising:
a head;
a first section extending from said head and defining a first outside diameter, said first section being unthreaded; and
a second section co-axially extending from said first section and defining a second outside diameter, said second section being threaded, said second outside diameter being smaller than said first outside diameter.

2. The fastener according to claim 1, further comprising:
a thread cover positionable over said second section.

3. The fastener according to claim 2, further comprising:
a transition section disposed between said first section and said second section.

4. The fastener according to claim 3 wherein said transition section is tapered.

5. The fastener according to claim 3 wherein said transition section is orthogonal to an axis of said first section.

6. The fastener according to claim 2 wherein said thread cover defines a third outside diameter and comprises a tapered end transitioning from said third outside diameter to said first outside diameter.

7. The fastener according to claim 2 wherein said thread cover defines a third outside diameter that is less than said first outside diameter.

8. The fastener according to claim 2 wherein said thread cover defines a third outside diameter that is equal to said first outside diameter.

9. The fastener according to claim 2 wherein said thread cover defines a third outside diameter that is substantially equal to said first outside diameter.

10. The fastener according to claim 2 wherein said thread cover defines a third outside diameter that is complementary to said first outside diameter.
